(19) United States
(12) Patent Application Publication
(10) Pub. No.: US 2020/0285724 A1
(43) Pub. Date: Sep. 10, 2020

(54) BIOMETRIC AUTHENTICATION DEVICE, BIOMETRIC AUTHENTICATION SYSTEM, AND COMPUTER PROGRAM PRODUCT

(71) Applicant: FUJITSU CLIENT COMPUTING LIMITED, Kanagawa (JP)

(72) Inventor: Masaki Mukouchi, Kawasaki (JP)

(73) Assignee: FUJITSU CLIENT COMPUTING LIMITED, Kanagawa (JP)

(21) Appl. No.: 16/744,875

(22) Filed: Jan. 16, 2020

(30) Foreign Application Priority Data
Mar. 7, 2019 (JP) 2019-041909

(51) Int. Cl. G06F 21/32; G06K 9/00; G06K 9/32

(52) U.S. Cl. CPC G06F 21/32; G06K 9/00033; G06K 2009/00395; G06K 9/00382; G06K 9/3241; G06K 9/00912

(57) ABSTRACT

A biometric authentication device incudes: processing circuitry that implements a reception unit that receives an input of identification information of a person to be authenticated; an image acquisition unit that acquires an image of a target part of the person to be authenticated, the image taken by a camera; a guide display unit that acquires guide information associated with the identification information received by the reception unit from a file in which the identification information is associated with the guide information indicating a guide shape that is a geometric shape for positioning the target part with respect to the camera, and that causes a display device to display the guide shape indicated by the acquired guide information and the image acquired by the image acquisition unit; and an authentication unit that performs authentication based on the image acquired by the image acquisition unit.

### CROSS-REFERENCE TO RELATED APPLICATIONS

This application is based upon and claims the benefit of priority from Japanese Patent Application No. 2019-041909, filed Mar. 7, 2019, the entire contents of which are incorporated herein by reference.

### FIELD

The present disclosure relates generally to a biometric authentication device, a biometric authentication system, and a computer program product.

BACKGROUND

In the related art, for example, there is known a biometric authentication device that images a palm of a person to be authenticated with a camera after receiving an input of identification information of the person to be authenticated, and performs authentication based on an image obtained through the imaging and biological information for collation. As such a kind of biometric authentication device, there is known a device that causes a display unit to display a guide shape for guiding the palm to an appropriate position with respect to the camera in imaging performed with the camera.

### SUMMARY

According to an aspect of the present invention, a biometric authentication device incudes processing circuitry configured to implement a reception unit, an image acquisition unit, a guide display unit, and an authentication unit. The reception unit is configured to receive an input of identification information of a person to be authenticated. The image acquisition unit is configured to acquire an image of a target part of the person to be authenticated, the image being taken by a camera. The guide display unit is configured to acquire guide information associated with the identification information received by the reception unit from a file in which the identification information is associated with the guide information indicating a guide shape being a geometric shape for positioning the target part with respect to the camera, and cause a display device to display the guide shape indicated by the acquired guide information and the image acquired by the image acquisition unit. The authentication unit is configured to perform authentication based on the image acquired by the image acquisition unit.

According to another aspect of the present invention, a biometric authentication system includes a wide-angle camera, a display device, and a biometric authentication device. The biometric authentication device includes processing circuitry configured to implement a reception unit, an image acquisition unit, a guide display unit, and an authentication unit. The reception unit is configured to receive an input of identification information of a person to be authenticated. The image acquisition unit is configured to acquire an image of a target part of the person to be authenticated, the image being taken by the wide-angle camera. The guide display unit is configured to acquire guide information associated with the identification information received by the reception unit from a file in which the identification information is associated with the guide information indicating a guide shape being a geometric shape for positioning the target part with respect to the wide-angle camera, and cause a display device to display the guide shape indicated by the acquired guide information and the image acquired by the image acquisition unit. The authentication unit is configured to perform authentication based on the image acquired by the image acquisition unit.

According to still another aspect of the present invention, a computer program product includes programmed instructions embodied in and stored on a non-transitory computer readable medium. The instructions, when executed by a computer, cause the computer to function as a reception unit, an image acquisition unit, a guide display unit, and an authentication unit. The reception unit is configured to receive an input of identification information of a person to be authenticated. The image acquisition unit is configured to acquire an image of a target part of the person to be authenticated, the image being taken by a camera. The guide display unit is configured to acquire guide information associated with the identification information received by the reception unit from a file in which the identification information is associated with the guide information indicating a guide shape being a geometric shape for positioning the target part with respect to the camera, and cause a display device to display the guide shape indicated by the acquired guide information and the image acquired by the image acquisition unit. The authentication unit is configured to perform authentication based on the image acquired by the image acquisition unit.

### BRIEF DESCRIPTION OF THE DRAWINGS

FIG. 1 is a perspective view illustrating an example of an electronic appliance according to an embodiment;

FIG. 2 is a diagram illustrating an example of a guide screen displayed on a display device of the electronic appliance according to the embodiment;

FIG. 3 is a block diagram illustrating an example of a configuration of the electronic appliance according to the embodiment;

FIG. 4 is a diagram illustrating an example of a registration file according to the embodiment;

FIG. 5 is a block diagram illustrating an example of a functional configuration of the electronic appliance according to the embodiment;

FIG. 6 is a flowchart illustrating an example of registration processing performed by a control device of the electronic appliance according to the embodiment;

FIG. 7 is an explanatory diagram for explaining a case in which a relatively large hand is held in front of a camera according to the embodiment;

FIG. 8 is an explanatory diagram for explaining a case in which a relatively small hand is held in front of the camera according to the embodiment;

FIG. 9 is a diagram illustrating an example of an image taken by the camera according to the embodiment, which is taken in the state of FIG. 7;

FIG. 10 is a diagram illustrating an example of an image taken by the camera according to the embodiment, which is taken in the state of FIG. 8;

FIGS. 11A and 11B are explanatory diagrams for explaining an example of a method of determining an outside shape image of a palm according to the embodiment;

FIG. 12 is a flowchart illustrating an example of biometric authentication processing performed by the control device of the electronic appliance according to the embodiment;

FIG. 13 is a diagram illustrating an example of a guide screen displayed on the display device of the electronic appliance according to the embodiment, which is the guide screen on which a dummy guide shape is displayed;

FIG. 14 is a diagram illustrating a relation between a certain ID and ASCII codes according to the embodiment;

FIG. 15 is a diagram illustrating an example of a registration file according to a first modification of the embodiment; and

FIGS. 16A and 16B are diagrams for explaining a method of determining a guide shape according to a second modification of the embodiment.

### DETAILED DESCRIPTION

The following discloses an exemplary embodiment of the present invention. A configuration of the embodiment described below, and operations and effects obtained through the configuration are merely examples. The present invention can be implemented with a configuration other than the configuration disclosed in the following embodiment. According to the present invention, it is possible to obtain at least one of various effects (including derivative effects) obtained through the configuration.

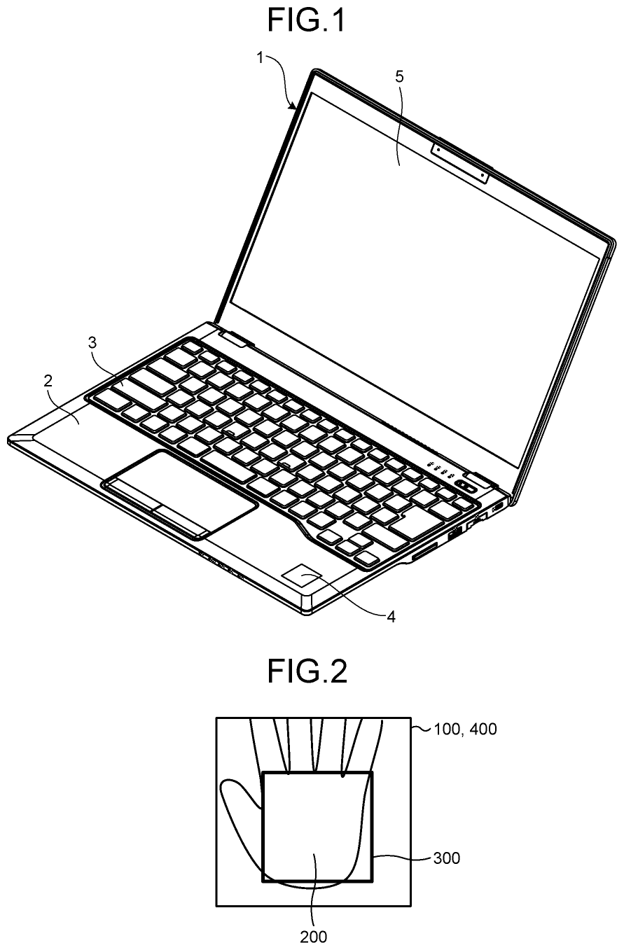

FIG. 1 is a perspective view illustrating an example of an electronic appliance 1 according to the embodiment. As illustrated in FIG. 1, for example, the electronic appliance 1 is configured as a notebook (clamshell) personal computer, and includes a base housing 2, an input device 3, a camera 4, and a display device 5. The electronic appliance 1 is not limited to the example described above, and may be, for example, a desktop personal computer, a slate (tablet) personal computer, a smartphone, a cellular telephone, a video display device, a television receiver set, a game machine, and the like.

FIG. 2 is a diagram illustrating an example of a guide screen 100 displayed on the display device 5 of the electronic appliance 1 according to the embodiment. The electronic appliance 1 performs biometric authentication processing at the time when the electronic appliance 1 is started up, for example. By way of example, the biometric authentication processing is palm vein authentication processing. In the biometric authentication processing, first, the display device 5 displays an ID input screen (not illustrated) for receiving an input of an ID as identification information with which a user can be identified. Hereinafter, the ID of the user is also referred to as a user ID. When the ID is input to the ID input screen, the display device 5 displays the guide screen 100 as illustrated in FIG. 2, and the camera 4 starts to perform imaging at the same time. The user holds a palm 200 in front of the camera 4. On the guide screen 100, displayed are a guide shape 300 for positioning the palm 200 with respect to the camera 4, and a taken image 400 that is an image taken by the camera 4. The guide shape 300 and the taken image 400 are overlapped with each other to be displayed (superimposed display). Authentication is then performed based on the taken image 400. Details about the biometric authentication processing will be described later. The electronic appliance 1 is an example of an authentication system. The user is an example of a person to be authenticated. The biometric authentication processing is not limited to the palm vein authentication processing. For example, the biometric authentication processing may be iris authentication processing and the like utilizing an iris of an eye, or fingerprint authentication processing utilizing a fingerprint.

The following describes respective components of the electronic appliance 1 in detail.

As illustrated in FIG. 1, the input device 3 is fixed to the base housing 2. The input device 3 includes a keyboard, a touch pad, and the like.

The camera 4 is fixed to the base housing 2. The camera 4 is configured as an area camera (area sensor) that can output a color or monochrome two-dimensional image by imaging a subject (in the present embodiment, a hand of a human body). The camera 4 is, for example, a camera having an imageable angle equal to or larger than 60 degrees. The imageable angle of the camera 4 is not limited thereto. The camera 4 is not necessarily a wide-angle camera.

The display device 5 is supported by the base housing 2 in a rotatable manner. The display device 5 is a liquid crystal display, an organic display, and the like.

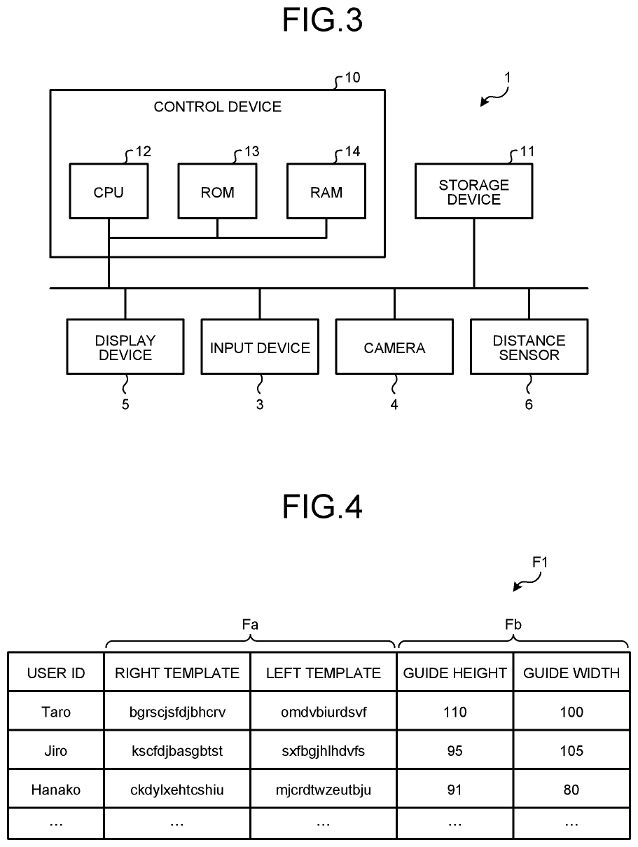

FIG. 3 is a block diagram illustrating an example of the configuration of the electronic appliance 1 according to the embodiment. The electronic appliance 1 includes a control device 10 and a storage device 11.

The control device 10 includes a central processing unit (CPU) 12, a read only memory (ROM) 13, and a random access memory (RAM) 14. That is, the control device 10 has a hardware configuration of a typical computer. The CPU 12 reads out and executes a computer program stored in the ROM 13, the storage device 11, and the like. The CPU 12 is configured to be able to perform various kinds of arithmetic processing in parallel. The RAM 14 temporarily stores various kinds of data to be used when the CPU 12 executes the computer program to perform various kinds of arithmetic processing. The display device 5, the input device 3, the camera 4, the storage device 11, and a distance sensor 6 are connected to the control device 10.

The storage device 11 is, for example, a hard disk drive (HDD), a solid state drive (SSD), and the like. The storage device 11 stores an operating system (OS), a computer program, various files, and the like. Each of the various files stored in the storage device 11 includes a registration file F1 (FIG. 4). The registration file F1 is an example of a file. The storage device 11 is an example of a recording medium in which the computer program is recorded.

FIG. 4 is a diagram illustrating an example of the registration file F1 according to the embodiment. As illustrated in FIG. 4, IDs of users (in FIG. 4, user IDs) are registered in the registration file F1. The registration file F1 stores biological information for collation Fa and guide information Fb for each of the IDs of the users (in FIG. 4, the user IDs). That is, the registration file F1 stores the ID of the user, the biological information for collation Fa, and the guide information Fb in association with each other. The biological information for collation Fa is collated with the taken image 400 taken by the camera 4 in the biometric authentication processing. The biological information for collation Fa is a template of an image of a vein of the palm 200. The biological information for collation Fa includes a right template and a left template. The right template is the biological information for collation of a vein of the palm 200 of a right hand of the user, and the left template is the biological information for collation of a vein of the palm 200 of a left hand of the user. The guide information Fb is information indicating the guide shape 300. In the present embodiment, by way of example, the guide shape 300 is a geometric shape. Specifically, the guide shape 300 is a rectangular frame shape, and the guide information Fb includes a vertical (a vertical direction of FIG. 2) length (in FIG. 4, a guide height) of the guide shape 300 and a horizontal (a horizontal direction of FIG. 2) length (in FIG. 2, a guide width) thereof.

The distance sensor 6 illustrated in FIG. 3 measures a distance between the camera 4 and the palm 200 as a subject. The distance sensor 6 is fixed to the base housing 2.

Next, the following describes registration processing and the biometric authentication processing among various kinds of processing performed by the control device 10.

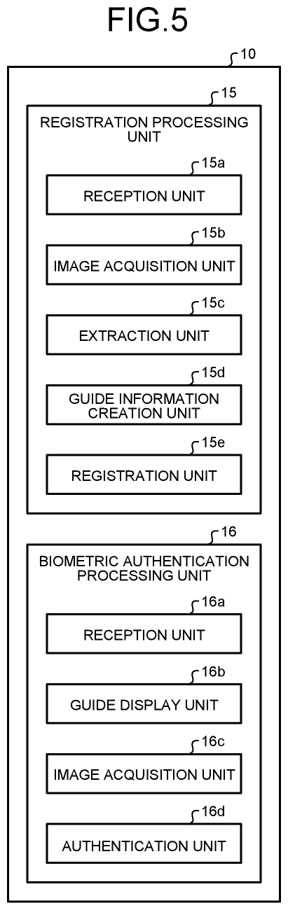

FIG. 5 is a block diagram illustrating an example of a functional configuration of the electronic appliance 1 according to the embodiment. As illustrated in FIG. 5, the control device 10 includes, as functional configurations, a registration processing unit 15 that performs the registration processing, and a biometric authentication processing unit 16 that performs the biometric authentication processing. The registration processing unit 15 includes a reception unit 15a, an image acquisition unit 15b, an extraction unit 15c, a guide information creation unit 15d, and a registration unit 15e. The biometric authentication processing unit 16 includes a reception unit 16a, a guide display unit 16b, an image acquisition unit 16c, and an authentication unit 16d. Each of the functional configurations is implemented as a result of execution of the computer program stored in the storage unit such as the ROM 13, the storage device 11, and the like by the CPU 12. Part or all of the functional configurations described above may be implemented by dedicated hardware (circuit).

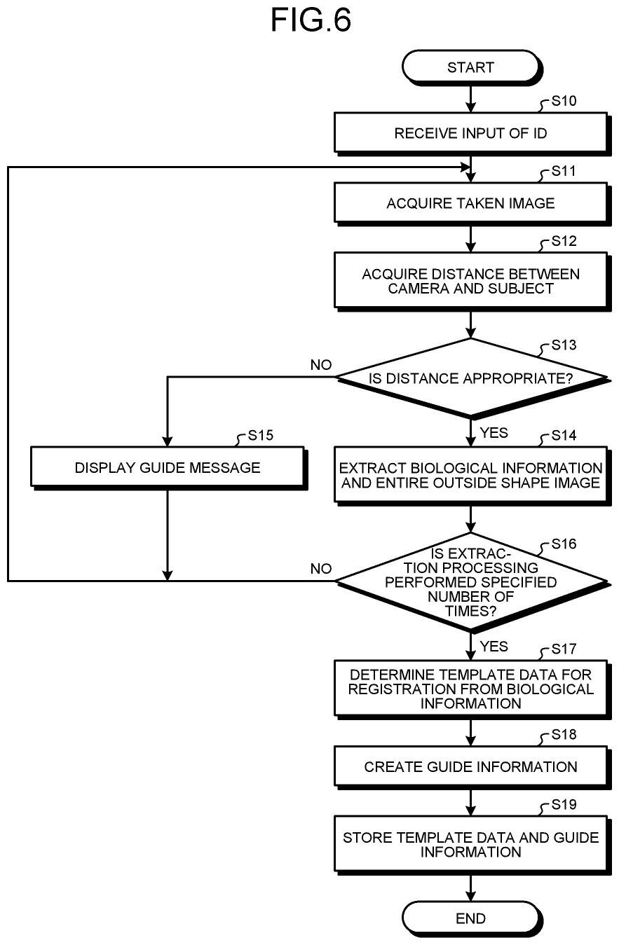

FIG. 6 is a flowchart illustrating an example of the registration processing performed by the control device 10 of the electronic appliance 1 according to the embodiment. In the following registration processing, it is assumed that the ID is already registered in the registration file F1.

As illustrated in FIG. 6, the reception unit 15a of the registration processing unit 15 receives an input of the ID (S10). For example, the reception unit 15a causes the display device 5 to display the ID input screen (not illustrated), receives an input of the ID, and determines whether the ID is registered in the registration file F1. The ID is input to the ID input screen by the input device 3 operated by the user. When the ID the input of which is received by the reception unit 15a is not registered in the registration file F1, the reception unit 15a causes the display device 5 to display the ID input screen again.

When the ID the input of which is received by the reception unit 15a is registered in the registration file F1, the image acquisition unit 15b causes the display device 5 to display a message (not illustrated) such as “Hold the palm 200 in front of the camera 4”, and acquires the taken image 400 taken by the camera 4 from the camera 4 (S11). Specifically, the image acquisition unit 15b receives the taken image 400 from the camera 4. At this point, when the user holds the palm 200 in front of the camera 4, an image of the palm 200 is included in the taken image 400.

Next, the image acquisition unit 15b acquires a distance from the camera 4 to the subject (in the present embodiment, the hand) (S12), and determines whether the distance is appropriate (S13). The distance from the camera 4 to the subject is a distance from the camera 4 to the subject in a direction along an optical axis of the camera 4. The distance from the camera 4 to the subject is measured by the distance sensor 6, and the image acquisition unit 15b acquires the measured distance from the distance sensor 6. Alternatively, the distance from the camera 4 to the subject may be calculated based on the taken image 400.

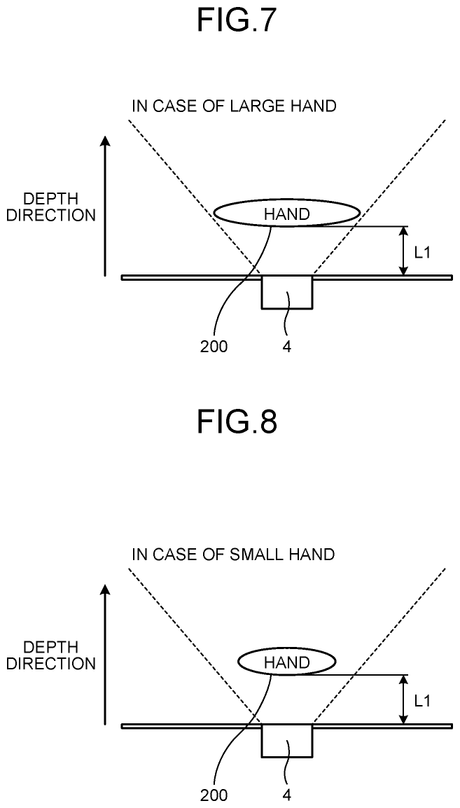

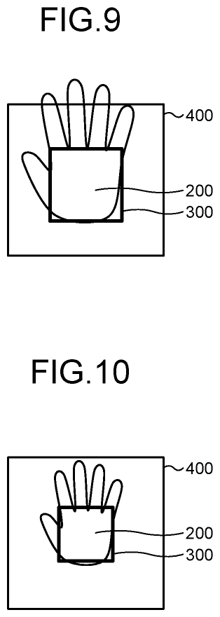

The following describes a position of the hand as the subject with respect to the camera 4. FIG. 7 is an explanatory diagram for explaining a case in which a relatively large hand is held in front of the camera 4 according to the embodiment. FIG. 8 is an explanatory diagram for explaining a case in which a relatively small hand is held in front of the camera 4 according to the embodiment. FIG. 9 is a diagram illustrating an example of the image taken by the camera 4 according to the embodiment, which is taken in the state of FIG. 7. FIG. 10 is a diagram illustrating an example of the image taken by the camera 4 according to the embodiment, which is taken in the state of FIG. 8.

As illustrated in FIG. 7 and FIG. 8, in imaging of the hand performed by the camera 4, it is preferable that the hand is distant from the camera 4 by a focal distance L1 of the camera 4 irrespective of the size of the hand. A direction away from the camera 4 along the optical axis of the camera 4 on an imaging region side (an upper side in FIG. 7 and FIG. 8) of the camera 4 is also referred to as a depth direction. The taken image 400 that is taken in such a state is illustrated in FIG. 9 and FIG. 10. As can be seen from FIG. 9 and FIG. 10, the size of the hand in the taken image 400 varies depending on the size of the hand. Thus, as described later, the guide shape 300 is set in accordance with the size of the hand. That is, a plurality of the guide shapes 300 set for the respective IDs may have shapes and sizes different from each other.

Returning to FIG. 6, at S13, if an absolute value of a difference between the distance from the camera 4 to the subject and the focal distance L1 of the camera 4 is equal to or smaller than a threshold, the image acquisition unit 15b determines that the distance from the camera 4 to the subject is appropriate (Yes at S13). In this case, the extraction unit 15c extracts, from the taken image 400, the biological information and an entire outside shape image as an image of the outside shape of the human body (S14). The biological information is an image of the vein. If the absolute value of the difference between the distance from the camera 4 to the subject and the focal distance L1 of the camera 4 exceeds the threshold, the image acquisition unit 15b determines that the distance from the camera 4 to the subject is not appropriate (No at S13). In this case, the image acquisition unit 15b causes the display device 5 to display a guide message to prompt the user to move his/her hand so that the distance becomes an appropriate distance (S15).

At S13, the image acquisition unit 15b may also determine whether the position of the subject with respect to the camera 4 in a direction orthogonal to the optical axis of the camera 4 is appropriate using a known method. In this case, if it is determined that the distance from the camera 4 to the subject and the position of the subject with respect to the camera 4 in the direction orthogonal to the optical axis of the camera 4 are not appropriate (No at S13), the image acquisition unit 15b causes the display device 5 to display a guide message for prompting the user to move his/her hand so that the distance and the position become an appropriate distance and an appropriate position (S15). In this case, if the image acquisition unit 15b determines that the distance from the camera 4 to the subject and the position of the subject with respect to the camera 4 in the direction orthogonal to the optical axis of the camera 4 are appropriate (Yes at S13), the extraction unit 15c extracts, from the taken image 400, the biological information and the entire outside shape image as an image of the outside shape of the human body (S14).

If the processing at S10 to S15 described above is not performed a specified number of times (No at S16), the processing at S10 to S15 described above is performed again. That is, the extraction unit 15c extracts the biological information and the entire outside shape image from each of a specified number of the taken images 400 (Yes at S16).

Next, the extraction unit 15c determines template data for registration in the registration file F1 from a specified number of pieces of biological information using a known method (S17). At this point, the extraction unit 15c can extract a candidate for the template data from each average of the specified number of pieces of biological information, and take an average of candidates to obtain the template data. The template data is the biological information that is caused to be a template.

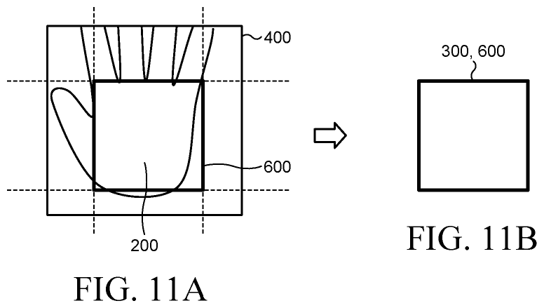

Next, the guide information creation unit 15d creates the guide information Fb based on the taken image 400 (S18). FIG. 11 is an explanatory diagram for explaining an example of a method of extracting the outside shape image of the palm 200 according to the embodiment. As illustrated in FIG. 11, first, the guide information creation unit 15d extracts an outside shape image 600 of the palm 200 based on a feature point such as a root of a finger of the hand in the taken image 400 (in FIG. 11A). The outside shape image 600 of the palm 200 is extracted in a rectangular frame shape (in FIG. 11B). The extraction unit 15c then determines the outside shape image 600 that is extracted as described above to be the guide information. That is, the extraction unit 15c causes the outside shape image 600 to be the guide shape 300.

Next, the registration processing unit 15 stores, in the registration file F1, the template data extracted by the extraction unit 15c and the guide information Fb created by the guide information creation unit 15d (S19). The processing described above is performed on both of the left and the right hands. At this point, the guide information Fb stored in the registration file F1 may be the guide information of any one of the left and the right hand, or may be an average value of pieces of the guide information Fb of the left and the right hands.

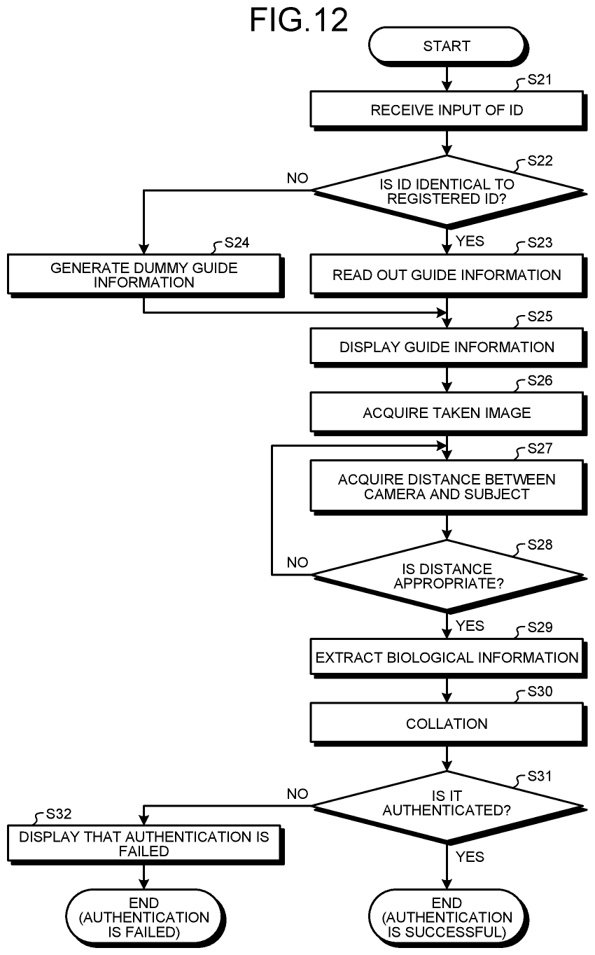

Next, the following describes the biometric authentication processing in detail. FIG. 12 is a flowchart illustrating an example of the authentication processing performed by the control device 10 of the electronic appliance 1 according to the embodiment.

As illustrated in FIG. 12, first, the reception unit 16a of the biometric authentication processing unit 16 receives an input of the ID (S21). For example, the reception unit 16a causes the display device 5 to display the ID input screen (not illustrated), and receives the input of the ID. The ID is input to the ID input screen by the input device 3 operated by the user.

If the ID the input of which is received by the reception unit 16a is registered in the registration file F1 (Yes at S22), the guide display unit 16b reads out, from the registration file F1, the guide information Fb associated with the ID that is received at S21 (S23). The guide display unit 16b causes the display device 5 to display the read-out guide information Fb (S25, FIG. 2). Specifically, the guide display unit 16b causes the display device 5 to display the guide shape 300 indicated by the read-out guide information Fb. For example, the guide shape 300 is displayed so that a predetermined part of the guide shape 300 is positioned at a predetermined position in the guide screen 100. The predetermined part of the guide shape 300 is, for example, the center of the guide shape 300. The predetermined part of the guide shape 300 is not limited thereto. At this point, the guide display unit 16b also causes the display device 5 to display a message such as “Hold the palm 200 in front of the camera 4”. Additionally, the camera 4 starts to perform imaging at this point. When the user holds the palm 200 in front of the camera 4, the image of the palm 200 is included in the taken image 400 of the camera 4.

Next, the image acquisition unit 16c acquires, from the camera 4, the taken image 400 imaged by the camera 4 (S26). Specifically, the image acquisition unit 15b receives the taken image 400 from the camera 4.

Next, the image acquisition unit 15b acquires a distance between the camera 4 and the subject (hand) (S27). Next, the image acquisition unit 15b determines whether the distance acquired at S27 and the position of the subject with respect to the camera 4 is appropriate (S28). The processing at S27 and S28 is the same as the processing at S12 and S13 in FIG. 6, so that detailed description thereof will not be repeated. If the distance and the position described above are not appropriate (No at S28), the processing at S26 to S28 is repeated.

If the distance and the position described above are appropriate (Yes at S28), the authentication unit 16d extracts the biological information from the taken image 400 acquired at S26 using a known method (S29). That is, the authentication unit 16d extracts the biological information from the taken image 400.

The authentication unit 16d reads out, from the registration file F1, the biological information for collation Fa associated with the ID that is received at S21, and collates the biological information for collation Fa with the biological information extracted at S29 using a known method (S30). The authentication unit 16d performs authentication based on a collation result obtained at S30. For example, if a similarity between the biological information for collation and the biological information extracted at S29 is equal to or larger than a specified value, the authentication unit 16d authenticates it, that is, determines that the authentication is successful (Yes at S31), and if the similarity between the biological information for collation and the biological information extracted at S29 is smaller than the specified value, the authentication unit 16d does not authenticate it, that is, determines that the authentication is failed (No at S31). If the authentication is failed (No at S31), the authentication unit 16d causes the display device 5 to display information that the authentication is failed (S32).

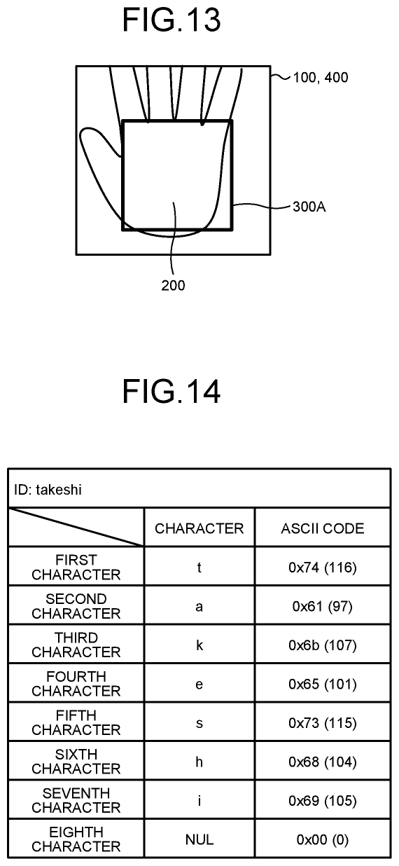

Next, the following describes a case in which the ID the input of which is received at S22 is not registered in the registration file F1 (No at S22). In this case, the guide display unit 16b generates guide information indicating a dummy guide shape 300A (FIG. 13) (S24). The guide display unit 16b then causes the display device 5 to display the dummy guide shape 300A indicated by dummy guide information that is set as described above (S25). At this point, the guide display unit 16b sets the dummy guide shape 300A corresponding to an ID that is not registered. FIG. 13 is a diagram illustrating an example of the guide screen 100 displayed on the display device 5 of the electronic appliance 1 according to the embodiment, which is the guide screen 100 on which the dummy guide shape 300A is displayed. As illustrated in FIG. 13, the dummy guide shape 300A has a rectangular frame shape similarly to the proper guide shape 300 that is not a dummy. Similarly to the guide shape 300, for example, the dummy guide shape 300A is displayed so that a predetermined part of the dummy guide shape 300A is positioned at a predetermined position in the guide screen 100. Hereinafter, the guide information indicating the dummy guide shape 300A is also referred to as dummy guide information.

The following describes a method of setting the dummy guide shape 300A. For example, the guide display unit 16b sets the dummy guide shape 300A based on an ASCII code of a character in the ID.

The guide display unit 16b obtains a vertical length (guide height) of the dummy guide shape 300A by the following expression (1), and obtains a horizontal length (guide width) of the dummy guide shape 300A by the following expression (2). A unit of the length is cm, by way of example.

Guide height=(the first character×the second character−the fifth character×the sixth character)/1000+100 (1)

Guide width=(the third character×the fourth character−the seventh character×the eighth character)/1000+100 (2)

The ASCII code corresponding to the character in the ID is input to the n-th character (n is a positive number) of the expressions (1) and (2) described above.

FIG. 14 is a diagram illustrating a relation between a certain ID (takeshi) and ASCII codes according to the embodiment. The following result is obtained by substituting the ASCII codes of “takeshi” illustrated in FIG. 13 for the respective expressions (1) and (2) described above.

Guide height=(116×97−115×104)/1000+100=99

Guide width=(107×101−105×0)/1000+100=110

As described above, the guide display unit 16b of the control device 10 (biometric authentication device) according to the embodiment acquires the guide information Fb associated with the ID received by the reception unit 16a from the registration file F1 in which the guide information Fb indicating the guide shape 300 being a geometric shape for positioning the palm 200 (object part) with respect to the camera 4 is associated, and causes the display device 5 to display the guide shape 300 indicated by the acquired guide information Fb and the taken image 400 acquired by the image acquisition unit 16c. Thus, according to the present embodiment, for example, the guide shape 300 appropriate for each of a plurality of persons to be authenticated can be displayed while suppressing increase in the data amount of the guide information Fb as compared with a case of displaying the taken image of the human body as the guide shape. Accordingly, a speed of the authentication processing can be increased, and a data communication load can be reduced.

In the present embodiment, for example, the guide shapes 300 and 300A are a frame shape. Thus, the guide shapes 300 and 300A are relatively simple, so that increase in a data amount of the guide information Fb tends to be suppressed. The guide shapes 300 and 300A are not limited thereto. For example, the guide shapes 300 and 300A may be a cross shape, a single line shape, and the like. The frame shape of the guide shapes 300 and 300A is not limited to the rectangular shape. For example, the frame shape of the guide shapes 300 and 300A may be a circle, an ellipse, or a polygon other than a rectangle. The guide shapes 300 and 300A may have similar shapes having different sizes.

In the present embodiment, for example, the guide display unit 16b causes the display device 5 to display the dummy guide shape 300A when the ID received by the reception unit 16a is not registered in the registration file F1. Due to this, a registration state of the identification information is hardly estimated. The proper guide shape 300 is also referred to as a registered guide shape or a first guide shape, and the dummy guide shape 300A is also referred to as a non-registered guide shape or a second guide shape.

According to the present embodiment, the guide display unit 16b sets the dummy guide shape 300A in accordance with the ID. Thus, the dummy guide shape 300A varies depending on the ID, so that the registration state of the identification information is more hardly estimated as compared with a case in which there is one dummy guide shape 300A.

In the present embodiment, the camera 4 is a wide-angle camera. Thus, the distance between the palm 200 (object part) of the user and the camera 4 can be easily reduced.

Next, the following describes modifications of the embodiment.

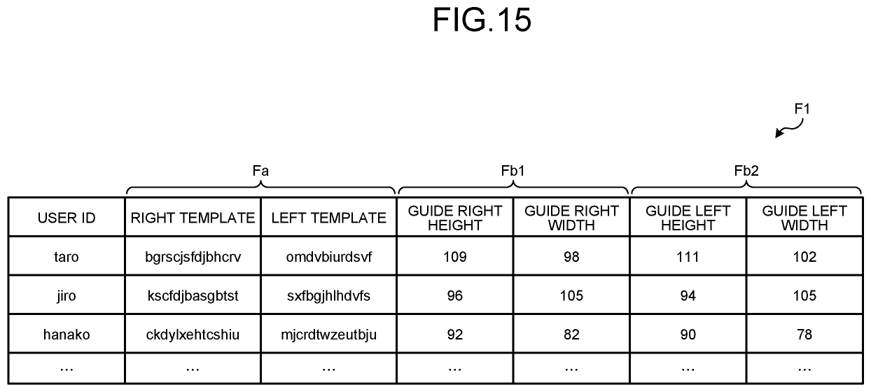

FIG. 15 is a diagram illustrating an example of the registration file F1 according to a first modification of the embodiment. As illustrated in FIG. 15, in the present modification, the registration file F1 stores pieces of guide information Fb1 and Fb2 for the respective left and right hands (object parts) of the person to be authenticated. The guide information Fb1 is the guide information indicating the guide shape for the palm 200 of the right hand of the user, and the guide information Fb2 is the guide information indicating the guide shape for the palm 200 of the left hand of the user. In the present modification, the guide display unit 16b causes the display device 5 to display any of the guide shapes corresponding to the left and the right hands. For example, the guide display unit 16b causes the display device 5 to display the guide shape indicated by the guide information Fb1 when a right button (not illustrated) is operated, and causes the display device 5 to display the guide shape indicated by the guide information Fb2 when a left button (not illustrated) is operated.

According to the first modification described above, the guide display unit 16b causes the display device 5 to display any of the guide shapes 300 corresponding to the left and the right hands (object parts), so that convenience is improved as compared with a configuration of displaying only one of the left and the right hand.

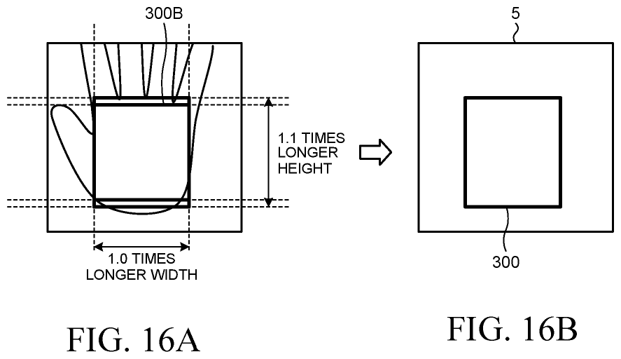

FIG. 16 is a diagram for explaining a method of determining the guide shape 300 according to a second modification of the embodiment. As illustrated in FIG. 16, in the present modification, the guide information creation unit 15d sets a magnification (relative value) with respect to a guide shape 300B as a specified standard (in FIG. 16A). In the example of FIG. 16, the size of the extracted outside shape of the palm 200 is 1.1 times longer in a vertical direction and 1.0 times longer in a horizontal direction as compared with the guide shape 300B as the standard. The magnification is not limited thereto. The guide information creation unit 15d stores the magnification in the registration file F1 as the guide information Fb. The guide display unit 16b causes the display device 5 to display the guide shape 300 in accordance with the set magnification (FIG. 16B).

In the embodiment described above, as the authentication system, described is the example of the electronic appliance 1 including the control device 10 as an authentication device, the camera 4, the display device 5 in an integrated manner, but the embodiment is not limited thereto. For example, the authentication device, the camera 4, and the display device 5 in the authentication system are not necessarily integrated with each other. The authentication device may be, for example, a server or the like that is disposed separately from the electronic appliance 1.

According to an embodiment, it is possible to obtain the biometric authentication device, the biometric authentication system, and the computer program product that can display the guide shape appropriate for each of a plurality of persons to be authenticated while suppressing increase in the data amount of the guide shape.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is

1. A biometric authentication device comprising:
processing circuitry that implements
a reception unit that receives an input of identification information of a person to be authenticated,
an image acquisition unit that acquires an image of a target part of the person to be authenticated, the image being taken by a camera,
a guide display unit that acquires guide information associated with the identification information received by the reception unit from a file in which the identification information is associated with the guide information indicating a guide shape being a geometric shape for positioning the target part with respect to the camera, and that causes a display device to display the guide shape indicated by the acquired guide information and the image acquired by the image acquisition unit, and
an authentication unit that performs authentication based on the image acquired by the image acquisition unit.

2. The biometric authentication device according to claim 1, wherein the guide shape is a frame shape.

3. The biometric authentication device according to claim 1, wherein
the target part includes left and right target parts,
the guide shape includes guide shapes corresponding to the left and right target parts,
the file stores the guide information for each of the left and right target parts of the person to be authenticated, and
the guide display unit causes the display device to display any of the guide shapes corresponding to the left and right target parts.

4. The biometric authentication device according to claim 1, wherein the guide display unit causes the display device to display a dummy guide shape when the identification information received by the reception unit is not registered in the file.

5. The biometric authentication device according to claim 4, wherein the guide display unit sets the dummy guide shape in accordance with the identification information.

6. A biometric authentication system comprising:
a wide-angle camera;
a display device; and
a biometric authentication device, wherein
the biometric authentication device comprises:
processing circuitry that implements
a reception unit that receives an input of identification information of a person to be authenticated;
an image acquisition unit that acquires an image of a target part of the person to be authenticated, the image being taken by the wide-angle camera;
a guide display unit that acquires guide information associated with the identification information received by the reception unit from a file in which the identification information is associated with the guide information indicating a guide shape being a geometric shape for positioning the target part with respect to the wide-angle camera, and that causes a display device to display the guide shape indicated by the acquired guide information and the image acquired by the image acquisition unit; and
an authentication unit that performs authentication based on the image acquired by the image acquisition unit.

7. A computer program product including programmed instructions embodied in and stored on a non-transitory computer readable medium, the instructions cause a computer to function as:
a reception unit that receives an input of identification information of a person to be authenticated;
an image acquisition unit that acquires an image of a target part of the person to be authenticated, the image being taken by a camera;
a guide display unit that acquires guide information associated with the identification information received by the reception unit from a file in which the identification information is associated with the guide information indicating a guide shape being a geometric shape for positioning the target part with respect to the camera, and that causes a display device to display the guide shape indicated by the acquired guide information and the image acquired by the image acquisition unit; and
an authentication unit that performs authentication based on the image acquired by the image acquisition unit.
